(19) United States
(12) Patent Application Publication
(10) Pub. No.: US 2024/0310984 A1
(43) Pub. Date: Sep. 19, 2024

(54) LANDSCAPE SCREEN INTERACTION METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Xiaomeng YU, Beijing (CN); Chao SUN, Beijing (CN); Zhigao CHEN, Beijing (CN); Zhengke XU, Beijing (CN)

(21) Appl. No.: 18/573,566

(22) PCT Filed: Jul. 20, 2022
(86) PCT No.: PCT/CN2022/106717

§ 371 Date: Dec. 22, 2023

(30) Foreign Application Priority Data
Aug. 5, 2021 (CN) 202110898679.0

(51) Int. Cl. G06F 3/04845; G06F 3/0481

(52) U.S. Cl. CPC G06F 3/04845; G06F 3/0481

(57) ABSTRACT

Disclosed herein are a landscape screen interaction method and apparatus, an electronic device, and a storage medium. The landscape screen interaction method comprises: receiving a first trigger operation of a target interaction control acting on a video playback area of a first video in a landscape display page; in response to the first trigger operation, resizing the video playback area to a first display area of the landscape display page, and displaying first association information corresponding to the first video in a second display area of the landscape display page.

### CROSS-REFERENCE TO RELATED APPLICATIONS

The present application is a national phase application of International Application No. PCT/CN2022/106717, filed on Jul. 20, 2022, which claims the benefit of priority to the Chinese patent application No. 202110898679.0 filed with Chinese Patent Office on Aug. 5, 2021. Both applications are hereby incorporated by reference in their entirety into the present application.

### TECHNICAL FIELD

The present disclosure relates to the field of computer technologies, for example, to a landscape screen interaction method and apparatus, an electronic device, and a storage medium.

### BACKGROUND

With the continuous development of electronic technologies, electronic devices become more and more intelligent. Many users will watch videos on electronic devices. Because videos are often made in a landscape version, users tend to play the videos in a landscape manner in order to improve the picture impressions.

However, when a video is played on a landscape screen, if a user wants to view the video related information, he or she needs to interrupt playing of the video and jump to a new information presentation page to view the video related information. When it is needed to continue to watch the video, the original video playing interface is then manually switched back. Such information interaction mode has complex operations and a low interaction efficiency, and greatly influences the user's interaction experience.

### SUMMARY

An embodiment of the present disclosure provides a landscape screen interaction method and apparatus, an electronic device and a storage medium.

The present disclosure provides a landscape screen interaction method, comprising:
receiving a first trigger operation acting on a target interaction control of a video playing region of a first video in a landscape display page;
in response to the first trigger operation, resizing the video playing region to a first display region of the landscape display page, and presenting first associated information corresponding to the first video in a second display region of the landscape display page.

The present disclosure also provides a landscape screen interaction apparatus, comprising:
an interaction triggering module, configured to receive a first trigger operation acting on a target interaction control of a video playing region of a first video in a landscape display page;
a displaying module, configured to, in response to the first trigger operation, resize the video playing region to a first display region of the landscape display page, and presenting first associated information corresponding to the first video in a second display region of the landscape display page.

The present disclosure further provides an electronic device, comprising:
one or more processors;
a storage device, configured to store one or more programs;
when executed by the one or more processors, the one or more programs cause the one or more processors to implement the above-described landscape screen interaction method.

The present disclosure further provides a storage medium containing computer-executable instructions for performing the above-described landscape screen interaction when executed by a computer processor.

### BRIEF DESCRIPTION OF THE DRAWINGS

FIG. 1A is a schematic flow diagram of a landscape screen interaction method as provided in a first embodiment of the present disclosure;

FIG. 1B is a schematic diagram of an initial state of a landscape display page as provided in the first embodiment of the present disclosure;

FIG. 1C is a schematic structural diagram of a first display region and a second display region in a landscape display page as provided in the first embodiment of the present disclosure;

FIG. 1D is a schematic structural diagram of a first display region and a second display region in another landscape display page as provided in the first embodiment of the present disclosure;

FIG. 1E is a schematic structural diagram of a first display region and a second display region in a further landscape display page as provided in the first embodiment of the present disclosure;

FIG. 1F is a schematic effect diagram of presenting comment information of a first video based on the landscape screen interaction method of the embodiment of the present disclosure as provided in the first embodiment of the present disclosure;

FIG. 1G is a schematic effect diagram of presenting video information belonging to a same publisher as the first video based on the landscape screen interaction method of the embodiment of the present disclosure as provided in the first embodiment of the present disclosure;

FIG. 1H is a schematic effect diagram of presenting video information belonging to the same publisher as the first video based on the another landscape screen interaction method of the embodiment of the present disclosure as provided in the first embodiment of the present disclosure;

FIG. 2 is a schematic flow diagram of a landscape screen interaction method as provided in a second embodiment of the present disclosure;

FIG. 3 is a schematic flow diagram of a landscape screen interaction method as provided in a third embodiment of the present disclosure;

FIG. 4 is a schematic flow diagram of a landscape screen interaction method as provided in a fourth embodiment of the present disclosure;

FIG. 5 is a schematic structural diagram of a landscape screen interaction apparatus as provided in a fifth embodiment of the present disclosure;

FIG. 6 is a schematic structural diagram of an electronic device as provided in a sixth embodiment of the present disclosure.

### DETAILED DESCRIPTION

Embodiments of the present disclosure will be described below with reference to the accompanying drawings. While some embodiments of the present disclosure are shown in the drawings, the present disclosure can be embodied in various forms and these embodiments are provided for understanding the present disclosure. The drawings and embodiments of the present disclosure are for illustration purposes only.

The steps recited in method embodiments of the present disclosure can be performed in a different order, and/or performed in parallel. Moreover, method embodiments can include additional steps and/or omit performing the illustrated steps. The scope of the present disclosure is not limited in this respect.

The term “including” and variations thereof as used herein is intended to be open-ended, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

The “first”, “second”, and other concepts as mentioned in the present disclosure are only used for distinguishing different apparatuses, modules or units, and are not used for limiting the order in which functions are performed by the apparatuses, modules or units or the interdependencies of the apparatuses, modules or units.

Modifications of “one” or “more” as mentioned in the present disclosure are intended to be illustrative rather than limiting, and those skilled in the art will understand that it should be understood as “one or more” unless the context clearly indicates otherwise.

### First Embodiment

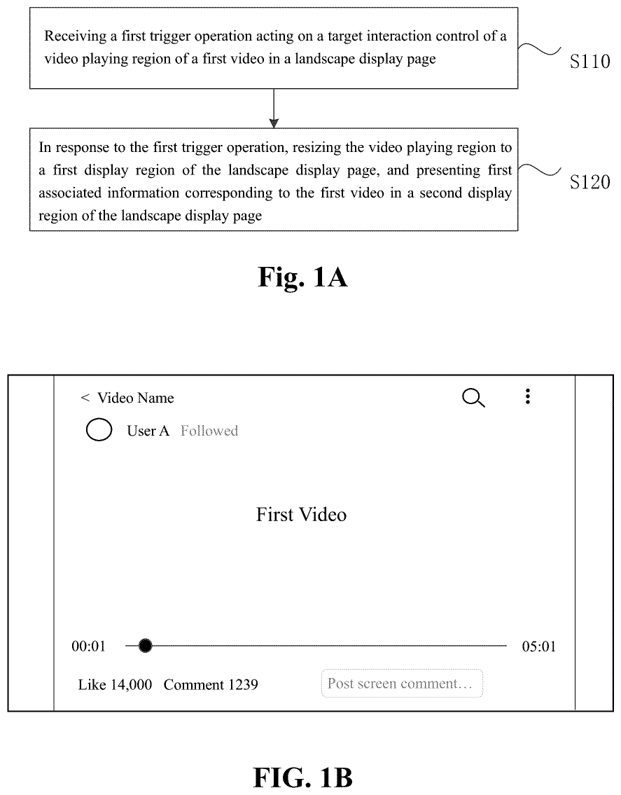

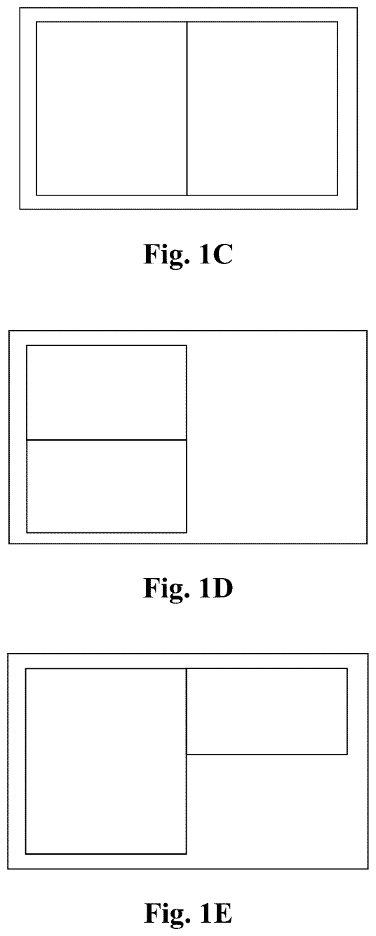

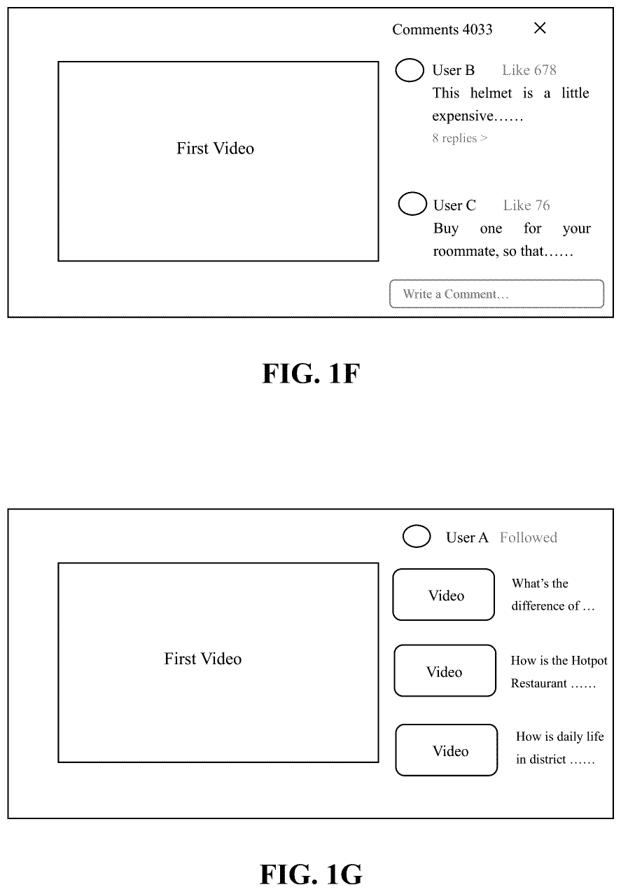

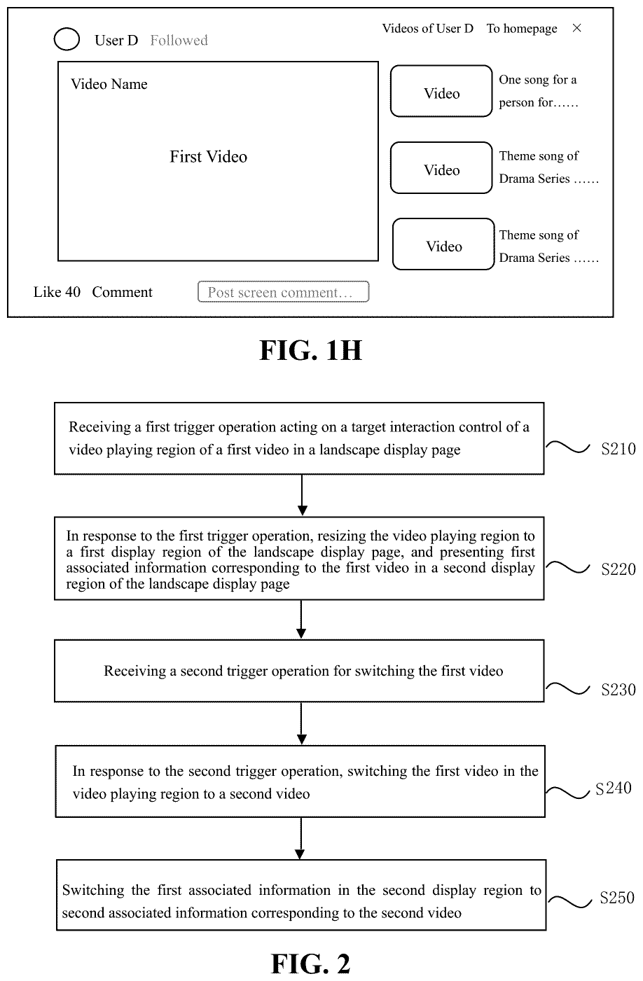

FIG. 1A is a schematic flow diagram of a landscape screen interaction method as provided in a first embodiment of the present disclosure. The embodiment of the present disclosure is applicable to a situation where information interaction is performed when watching a video. The method can be performed by a landscape screen interaction apparatus, and the apparatus can be implemented in form of software and/or hardware. The apparatus can be configured in a server to implement the landscape screen interaction method in the present disclosure in cooperation with a terminal. The server herein can be a single server, or a cluster of servers capable of providing one or more functions which are constituted by a plurality of communicatively connected servers. The landscape screen interaction method of the embodiment of the present disclosure can be applied to a mobile terminal. Accordingly, the landscape screen interaction apparatus according to the embodiment of the present disclosure can be configured in a mobile terminal.

As shown in FIG. 1A, the method of the present embodiment can comprise:

S110, receiving a first trigger operation acting on a target interaction control of a video playing region of a first video in a landscape display page.

The landscape display page can be understood as a page displayed when a screen of the electronic device is used horizontally. In order to ensure the presentation effect of the video, in practical applications, the video is generally made in a landscape version. FIG. 1B is a schematic diagram of an initial state of a landscape display page as provided in a first embodiment of the present disclosure. As shown in FIG. 1B, when a landscape display page is used to display a landscape video, a width of the screen corresponds to a width of the landscape video, a length of the screen corresponds to a length of the landscape video. An initial state of the landscape display page, namely an initial landscape page, can be a landscape full-screen page, and the first video is played in full screen in the landscape display page. At this time, the video can be often presented to the maximum extent by means of overspreading the video on the full screen.

In the embodiment of the present disclosure, the first video can be understood as a video displayed in the landscape display page at the current time. The video playing region of the first video can be understood as a display region of a video playing software for playing a video picture of the first video, i.e. a display region of a video player for playing a video. To correspond to the landscape display page, a video player on the landscape display page is a landscape player. Illustratively, the video playing region can include a video picture of the first video and at least one preset interaction control.

The interaction control can be understood as a control to be triggered for implementing an interaction function. In the embodiment of the present disclosure, the target interaction control can be understood as an interaction control triggered at the current time. A control identifier of the target interaction control can be displayed in a preset control region of the video playing region, wherein the control identifier can be provided in various forms of representation, for example, a picture or text. Illustratively, the preset control region can be an explicit region, for example, a region outside the video picture presentation region, which can generally be a peripheral region in the video playing region. Alternatively, the preset control region can also be an implicit region, for example, a region displayed on a video picture based on a received control trigger operation for triggering displaying of the target interaction control. As one embodiment of the present application, the control trigger operation for triggering displaying of the target interaction control can include performing a preset operation in a preset control trigger region. The preset operation can include, for example, completing a preset touch track, and the like.

In the embodiment of the present disclosure, the first trigger operation can be understood as a trigger operation acting on the target interaction control. There are various modes to trigger the target interaction control, for example, a click, a touch, or a press on the target interaction control. The click mode can be set according to actual requirements, which is not limited herein, and can be, for example, a single click or a double click. Similarly, the strength, time duration, and the like of the touch or the press can be set according to actual requirements, which is not limited herein, and can be, for example, a long press or a short press.

Illustratively, the target interaction control can include at least one of the following controls: a control for displaying publisher information of the first video, a control for displaying other video information of a publisher of the first video, a control for displaying recommended video information associated with the first video, and a control for displaying comment information of the first video.

S120, in response to the first trigger operation, resizing the video playing region to a first display region of the landscape display page, and presenting first associated information corresponding to the first video in a second display region of the landscape display page.

Illustratively, the associated information is information associated with a video, and the first associated information is information associated with the first video. The first associated information can include at least one of: home page information of a publisher of the first video, video information associated with a publisher of the first video, recommended video information, comment information, and the like. The above is only an explanation of the first associated information and is not limiting.

When a first trigger operation acting on a target interaction control of a video playing region of a first video in a landscape display page is received, the first associated information corresponding to the first trigger operation can be determined based on at least one interaction function corresponding to a preset target interaction control and the mode of action on the target interaction control.

The present disclosure provides an optimized landscape screen interaction solution. Compared with presenting the video associated information in a superposed way directly on an original video playing region, the present disclosure displays the first associated information in the second display region by resizing, e.g. scaling, and displaying the video playing region in the first display region, which avoids, to a certain extent, the influence of the associated information on video playing and improves the user experience.

In the embodiment of the present disclosure, after the video playing region is resized, the first video is played in landscape screen in the first display region, and the landscape display page can be divided into at least two display regions in advance. The landscape display page includes at least a first display region and a second display region. In other words, the landscape display page can include only the first display region and the second display region, or can include not only the first display region and the second display region but also display regions other than the first display region and the second display region. The first display region and the second display region can be two independent display regions. In some embodiments, the first display region and the second display do not obstruct each other.

FIG. 1C is a schematic structural diagram of a first display region and a second display region in a landscape display page as provided in the embodiment of the present disclosure. As shown in FIG. 1C, the landscape display page can include only the first display region and the second display region, and the first display region and the second display region can be two display regions having the same size. The first display region and the second display region can be arranged left and right. In one embodiment, the default setting can be that the first display region is located on the left side of the landscape display page and the second display region is located on the right side of the landscape display page. When resizing is performed, the video playing region is scaled down to the first display region in a first direction, and when resizing is disenabled, the video playing region is scaled up to the landscape full-screen display in a direction opposite to the first direction.

FIG. 1D is a schematic structural diagram of a first display region and a second display region in another landscape display page as provided in the embodiment of the present disclosure. As shown in FIG. 1D, the landscape display page can include not only the first display region and the second display region, but also display regions other than the first display region and the second display region. The first display region and the second display region can be two display regions arranged one above another. The first display region and the second display region can have the same or different display areas.

FIG. 1E is a schematic structural diagram of a first display region and a second display region in a further landscape display page as provided in the embodiment of the present disclosure. As shown in FIG. 1D, the landscape display page can include not only the first display region and the second display region, but also display regions other than the first display region and the second display region. The first display region and the second display region can be two display regions arranged left and right. In one embodiment, the default setting can be that the first display region is located on the left side of the landscape display page and the second display region is located on the right side of the landscape display page.

FIGS. 1C to 1E are merely illustrations for the structures of the first display region and the second display region in the landscape display page, instead of limitations of the setting mode for the first display region and the second display region.

As a technical solution of the embodiment of the present disclosure, the second display region is located in a region outside the first display region in the landscape display page. The landscape display page includes only the first display region and the second display region, and the first display region and the second display region are put together and overspreading the full landscape display interface. Such a setting has the advantage of maintaining the picture playing effect of the first video as much as possible while presenting the first associated information. The display area of the first display region can be the same with or different from the display area of the second display region.

The display area of the first display region and the display area of the second display region can be fixed default set values, or can be dynamically adjusted.

On the basis of any technical solution of the embodiment of the present disclosure, the landscape screen interaction method can further include: a received adjustment operation for adjusting a size of the display region, which acts on the first display region and/or the second display region; in response to the size adjustment operation, adjusting a display size of the first display region and/or the second display region. In other words, it is possible to, in response to the received size adjustment operation for adjusting a size of the display region, which acts on the first display region, adjust the display size of the first display region. It is also possible to, in response to the received size adjustment operation for adjusting a size of the display region, which acts on the first display region, adjust the display size of the first display region, and adjust the display size of the second display region based on the display size of the first display region. Similarly, it is also possible to, in response to the received size adjustment operation for adjusting a size of the display region, which acts on the second display region, adjust the display size of the second display region, and adjust the display size of the first display region based on the display size of the second display region.

The second display region is used for displaying the first associated information, and is very likely to generate interactive behaviors with a user. In order to adapt to watching habits of most users and in consideration of the operation convenience of the user whose dominant hand is the right hand, in one embodiment, the first display region is located on the left side of the landscape display page, and the second display region is located on the right side of the landscape display page.

resizing the video playing region to the first display region of the landscape display page can include scaling the video playing region based on a target scale ratio, and displaying the scaled video playing region in the first display region of the landscape display page. In one embodiment, the target scale ratio of the video playing region is determined according to the display size of the first display region and the current size of the video playing region. In one embodiment, the video playing region is scaled and then overspreading the full first display region. To achieve a smooth transition in visual effect, the video playing region can be scaled gradually to the first display region of the landscape display page.

Associated information of different types and associated information of different videos often contain different contents. Therefore, presenting the first associated information in the second display region of the landscape display page can include presenting the entire content of the first associated information in the second display region of the landscape display page, or presenting part of the content of the first associated information in the second display region of the landscape display page. In on embodiment, when part of the content of the first associated information is presented in the second display region and the first associated information is comment information, the display order and/or default display content of the comment information can be determined in accordance with at least one of popularity of the comment information, a number of users' likes, comment time, users who make comments and other information.

As a solution of the embodiment of the present disclosure, the receiving a first trigger operation acting on a target interaction control of a video playing region of a first video in a landscape display page includes: receiving a trigger operation acting on a comment identifier in the landscape display page; accordingly, the presenting first associated information corresponding to the first video in a second display region of the landscape display page includes: presenting first comment information corresponding to the first video in a second display region of the landscape display page.

When the first video is displayed in a landscape display page, an operation of clicking a comment button provided in a video playing region of the first video is received, the video playing region is resized to the first display region in the landscape display page, and the comment information of the first video is displayed in the second display region in the landscape display page. The comment information includes comment content and content of a reply to the comment. A lower region of the second display region can be further provided with a comment entrance to make comments, so that a user can make comments through the comment entrance.

FIG. 1F is a schematic effect diagram for presenting comment information of a first video based on the landscape screen interaction method of the embodiment of the present disclosure as provided in the embodiment of the present disclosure. As shown in FIG. 1F, it is possible to display the first video in the first display region located on the left side of the landscape display page, and display the comment information of the first video in the second display region located on the right side of the landscape display page. The comment information can include a number of comments which have been published, a publisher of the comment, a comment content, and so on.

As another solution of the embodiment of the present disclosure, the receiving a first trigger operation acting on a target interaction control of a video playing region of a first video in a landscape display page includes: receiving a trigger operation acting on a publisher identifier of the first video in the landscape display page; and accordingly, the presenting first associated information corresponding to the first video in a second display region of the landscape display page includes: presenting the video information published by a publisher corresponding to the first video in the second display region of the landscape display page.

Compared with triggering, in a landscape screen scene, the publisher identifier to directly jump out of the landscape page and into the publisher personal home page in a portrait screen and displaying publisher information related to the video, such as a video list, the present disclosure triggers a publisher identifier, resizes the video playing region to the first display region, and directly displays the publisher information related to the video in the second display region of the current landscape display page, which avoids interrupting the user and improves the user experience.

A publisher information view button of the video playing region in the first display region is clicked, and the video information of the same publisher as the first video is presented in the second display region.

FIG. 1G is a schematic effect diagram for presenting video information belonging to the same publisher as the first video based on the landscape screen interaction method of the embodiment of the present disclosure as provided in the first embodiment of the present disclosure. FIG. 1H is a schematic effect diagram for presenting video information belonging to the same publisher as the first video based on the another landscape screen interaction method of the embodiment of the present disclosure as provided in the first embodiment of the present disclosure. As shown in FIG. 1G and FIG. 1H, it is possible to display the first video in the first display region located on the left side of the landscape display page, and display video information belonging to the same publisher as the first video in the second display region located on the right side of the landscape display page. It is also possible to locate the first video information, in other words, display the video information of the first video in the second display region. The video information can include a video main map, a video duration, a video title, and the like.

As a solution of the embodiment of the present disclosure, the second display region can display a home page jump identifier. Accordingly, the landscape screen interaction method further comprises: receiving a trigger operation acting on a home page jump identifier in the second display region, and jumping to a portrait display page, wherein the portrait display page displays personal home page information of the publisher of the first video.

The home page jump identifier can be understood as a control for entering the publisher home page. That is, the home page jump control can be linked to the publisher's personal home page. The home page jump identifier can be provided in various forms of representation, for example, a text form, a picture form or a form combining picture and text. As shown in Fig. IF, the home page jump identifier can be presented in a text form, which can be presented as “Go to Home Page”. The home page jump button can be clicked to enter the publisher's personal home page. Illustratively, the home page jump button can be provided in an upper region of the second display region.

Considering that personal home page information is often designed in a portrait pattern, by triggering the home page jump control to jump to a portrait display page to view the publisher's personal home page information, it is possible to jump from the landscape display pattern to the portrait display pattern according to information layout, which provides better screen adaptability, ensures the presentation effect of the personal home page information, and improves the user experience.

In one embodiment, the second display region further displays publisher information of the publisher of the first video. The publisher information can be provided in various forms of representation, and can be set according to actual requirements in actual applications. In one embodiment, the publisher information includes a publisher avatar identifier and/or a publisher text identifier. Illustratively, the publisher text identifier can be a preset short sentence or phrase containing configurable items, such as “I am XX” or “a video of XX”, etc., where “XX” is a configurable item that can be matched with the publisher's user name.

Publisher information can also be linked to the publisher's personal home page. By triggering the publisher information, it is possible to jump to the publisher's personal home page to view details of the publisher's home page.

In the embodiment of the present disclosure, as shown in FIG. 1G, the second display region can further display a publisher interaction identifier. Illustratively, the publisher interaction identifier can be presented in a text form, such as “Follow”.

In one embodiment, when the second display region is required to display the first associated information, the video playing region of the first display region for playing the first video is scaled down. In one embodiment, the scaled-down video playing region still retains the original video information and the target interaction control that can include, for example, a publisher information view button, a follow button, a full-screen button, title, system information, a progress bar, a video duration, interactions (e.g., giving likes, making comment, making bullet screen comment), etc.

Continue with reference to FIG. 1H, the video playing region can further display publisher information of the publisher of the first video. It can be displayed in the upper left region of the video playing region. The publisher information can be presented in the forms as mentioned above, which are not described herein again. The video playing region can further display a comment button, a bullet screen comment control (which can include a bullet screen comment switch button and a bullet screen comment input box), a like-giving interaction button and the like. The comment button, the bullet screen comment control and the like-giving interaction button can be displayed in the lower region of the video playing region.

The above is merely an exemplary illustration, and not a limitation, of the display effect of the landscape display interface that can be implemented by using the landscape screen interaction method of the embodiment of the present disclosure. The display form and the arrangement mode of the plurality of interaction controls in the video playing region are not limited by the embodiment of the present disclosure.

In one implementation of the embodiment of the present disclosure, it is possible to, by means of clicking a designated hot region, dragging, sliding, and the like, open or close the second display region for carrying the first associated information, and meanwhile automatically scale the video playing region to the first display region, so that the first video and the target associated information do not obstruct each other, thereby improving the user experience.

In the technical solution of the embodiment of the present disclosure, by receiving a first trigger operation acting on a target interaction control of a video playing region of a first video in a landscape display page and determining first associated information corresponding to the first trigger operation, displaying of the first associated information can be triggered through the target interaction control of the video playing region, which has a simple trigger mode and is easy to operate. Then, in response to the first trigger operation, by resizing the video playing region to the first display region of the landscape display page and presenting the first associated information in the second display region of the landscape display page, the first video and the first associated information can be simultaneously displayed in the same landscape display page without a need to frequently switch pages, which solves the technical problem of complicated and inefficient information interaction in the related technologies, and achieves the technical effect of increasing information interaction efficiency, realizing high intelligence, and improving user interaction experience.

### Second Embodiment

FIG. 2 is a schematic flow diagram of a landscape screen interaction method as provided in a second embodiment of the present disclosure. The present embodiment can be combined with the solution of the above embodiment. In the present embodiment, the landscape screen interaction method further comprises: receiving a second trigger operation for switching the first video; in response to the second trigger operation, switching the first video in the video playing region to a second video.

On this basis, the landscape screen interaction method further comprises: switching the first associated information in the second display region to second associated information corresponding to the second video.

As shown in FIG. 2, the method of the present embodiment can comprise:

S210, receiving a first trigger operation acting on a target interaction control of a video playing region of a first video in a landscape display page.

S220, in response to the first trigger operation, resizing the video playing region to a first display region of the landscape display page, and presenting first associated information corresponding to the first video in a second display region of the landscape display page.

S230, receiving a second trigger operation for switching the first video.

The second trigger operation is an operation for triggering performance of a switching operation on the first video. The generation mode of the second trigger operation can be set according to actual requirements, which is not limited herein. For example, it can be at least one of performing a slide operation on the trigger object, performing a click operation on the trigger object, detecting a gesture of a target user in a preset trigger region, detecting user voice, or the like.

In one embodiment, receiving a second trigger operation for switching the first video includes: receiving a video switching operation acting on the first video. The video switching operation acting on the first video can be a slide operation on the first video. For example, it can be receiving a slide switching operation acting on a video playing picture of the first video. In one embodiment, the slide operation can be an upward slide, a downward slide, a leftward slide, a rightward slide, or the like. The input mode of the slide operation can be an input based on input apparatus or a touch input. In addition, the video switching operation acting on the first video can be a click operation or the like on the first video.

In the present disclosure, the videos are switched by sliding in the first display region, that is, triggering switching of the videos by sliding the video picture in the first display region, which realizes switching of videos in a landscape small window by sliding, and greatly facilitates a requirement for a user to view different videos in the landscape small window scene.

As described above, the first associated information can include video information belonging to the same publisher as the first video, or video information recommended according to the first video. In one embodiment, if the first associated information includes at least one recommended video, receiving a second trigger operation for switching the first video includes: receiving a selection operation acting on the recommended video. In other words, a selection operation of the presented video information in the second display region can be received, and then the first video in the first display region can be switched based on the selection operation.

In one embodiment, receiving a second trigger operation for switching the first video includes: receiving a switching operation acting on a preset video switching control in the video playing region. Illustratively, it can be clicking a video switching control of the video playing region.

S240, in response to the second trigger operation, switching the first video in the video playing region to a second video.

The second video corresponding to the second trigger operation can be determined based on a recommended playing order of a plurality of videos. In one embodiment, the recommended playing order of the plurality of videos can be determined according to a preset video recommendation rule. The video recommendation rule can be set according to requirements. The video recommendation rules for different video playing software can be the same or different, and the content of the rules is not limited herein. Illustratively, the video recommendation rule can include determining a user preference level based on behavior data authorized by user, and recommending a video based on the user preference level; or recommending a video with the most view counts at the present; or recommending a video belonging to the same publisher as the first video; or recommending a video of the same video type as the first video, and so on.

When the second trigger operation is received, a second video corresponding to the second trigger operation can be determined, and then the first video in the video playing region in the first display region is replaced with the second video.

Such a setting has an advantage that while the second display region displays the associated information, the video data source of the video playing region still belongs to an inside stream, and the inside stream video can still be switched by the second trigger operation.

S250, switching the first associated information in the second display region to second associated information corresponding to the second video.

The second associated information can be understood as associated information corresponding to the second video to be updated.

Before switching the first associated information in the second display region to second associated information corresponding to the second video, the method can further include: determining second associated information corresponding to the second video.

In one embodiment, second associated information corresponding to the second video is determined according to the first associated information. It can include acquiring associated information that corresponds to the second video and belongs to the same type as the first associated information, as second associated information corresponding to the second video. For example, if the first associated information is comment information for the first video, the second associated information corresponding to the second video can be comment information corresponding to the second video. If the first associated information is video list information for the video publisher corresponding to the first video, the second associated information is the video list information for the video publisher corresponding to the second video.

In one embodiment, the associated information corresponding to the second video displayed by default is used as the second associated information. The associated information displayed by default can be preset associated information. In practical applications, the associated information displayed by default can be set according to actual requirements, and which type of associated information is used as the default associated information is not limited herein. For example, the associated information displayed by default can be comment information corresponding to a video, video information of a same publisher, a personal home page of video publisher, recommended video information of the same type, and the like. The associated information displayed by default for different videos can be of the same type or different types.

Switching the first associated information in the second display region to the second associated information corresponding to the second video can include: stopping displaying of the first associated information in the second display region, and displaying the second associated information corresponding to the second video in the second display region. The first associated information is replaced or overwritten with the second associated information.

The second associated information can be different from or the same as the first associated information. In other words, after switching the first associated information in the second display region to the second associated information corresponding to the second video, the content of the associated information might or might not change.

As one implementation of the embodiment of the present disclosure, while the second display region is displaying the associated information, the first video can still be switched by operations, such as an upward slide, a downward slide, or the like, for the video playing region in the first display region. If the first video in the first display region is switched to the second video, then the first associated information in the second display region will also be automatically switched to the second associated information of the second video.

The technical solution of the present embodiment not only can simultaneously display the first video and the first associated information on the landscape display page, but also can switch the first video in the video playing region. It is also possible to switch the first associated information in the second display region to the second associated information corresponding to the updated second video, that is, when switching the video, it is also possible to accordingly switch the associated information related to the video, which realizes the linkage between the video displayed in the first display region and the associated information displayed in the second display region, and improves the user experience.

### Third Embodiment

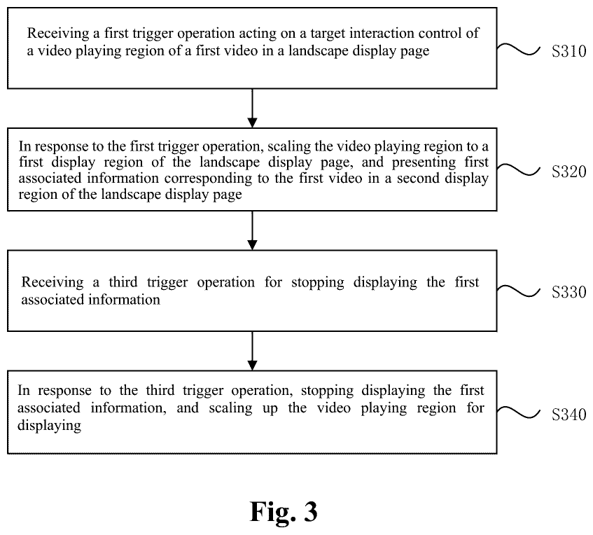

FIG. 3 is a schematic flow diagram of a landscape screen interaction method as provided in a third embodiment of the present disclosure. The present embodiment can be combined with the solution of the above embodiment. In the present embodiment, the landscape screen interaction method further comprises: receiving a third trigger operation for stopping displaying the first associated information; in response to the third trigger operation, stopping displaying the first associated information, and scaling up the video playing region for displaying.

As shown in FIG. 3, the method of the present embodiment can comprise:

S310, receiving a first trigger operation acting on a target interaction control of a video playing region of a first video in a landscape display page.

S320, in response to the first trigger operation, resizing the video playing region to a first display region of the landscape display page, and presenting first associated information corresponding to the first video in a second display region of the landscape display page.

S330, receiving a third trigger operation for stopping displaying the first associated information.

The third trigger operation can be understood as an operation executable for stopping displaying the first associated information after triggering.

In the embodiment of the present disclosure, the third trigger operation can be generated in various modes. Therefore, the mode for generating the third trigger operation can be selected according to actual requirements, and is not limited herein.

In one embodiment, receiving a third trigger operation for stopping displaying the first associated information includes: receiving a close trigger operation acting on the second display region. The close trigger operation acting on the second display region can include a slide or drag operation on the second display region, or a trigger on a region close control of the second display region, for example, clicking a preset region close button; or can include detecting gesture information or voice information for closing the second display region. The gesture information can be track information input based on the input apparatus, or can be a control gesture input in a touch mode or an induction mode.

S340, in response to the third trigger operation, stopping displaying the first associated information, and scaling up the video playing region for displaying.

Scaling up the video playing region for displaying can include: scaling up the video playing region to a target display region for displaying, wherein the target display region is determined according to the first display region and the second display region.

The target display region can be a maximum display region matching an enlargeable size of the video playing region, which is determined by putting together the first display region and the second display region. Illustratively, when the landscape display page only contains a first display region and a second display region, scaling up the video playing region for displaying can include putting together the first display region and the second display region to obtain a region as a target display region, or taking the entire landscape display page as the target display region, so that the video playing region can be scaled up for full-screen presentation.

In one embodiment, to achieve a smooth transition of video size change, the video playing region can be gradually scaled up.

In one embodiment of the present disclosure, the second display region can be located on the right side of the landscape display page, and the second display region can be closed by means of operations of clicking a hot region, sliding, and dragging. When the second display region is closed, the video playing region of the first display region on the left side of the landscape display page can be automatically scaled up and returns to the full-screen state.

The technical solution of the present embodiment not only can simultaneously display the first video and the first associated information on the landscape display page, but also, upon reception of the third trigger operation for stopping displaying the first associated information, can stop displaying the first associated information in response to the third trigger operation, that is, can independently perform the operation for closing the first associated information without closing the first video, and scale up the video playing region for displaying. It can achieve the technical effects of effectively ensuring the display effect of the first video and reasonably utilizing the display resources of the landscape display page, which is more intelligent and improves the user experience.

### Fourth Embodiment

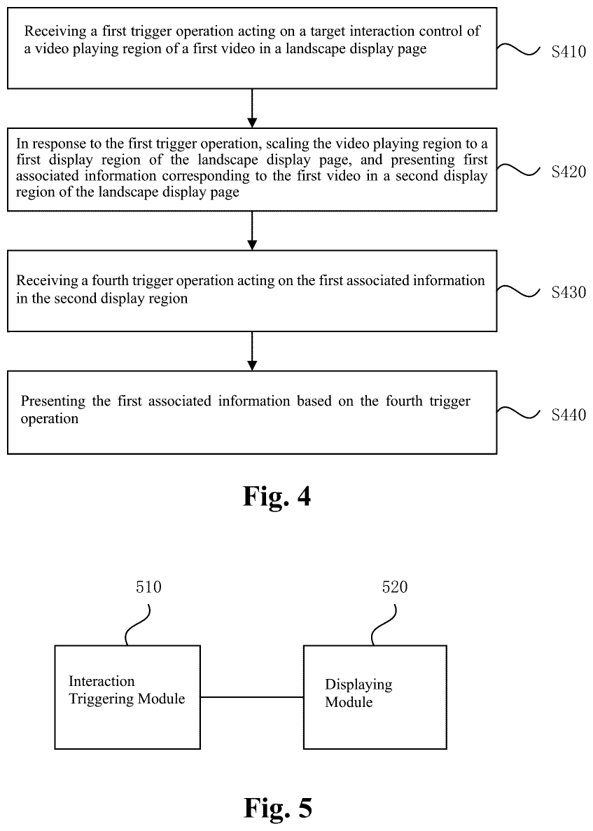

FIG. 4 is a schematic flow diagram of a landscape screen interaction method as provided in a fourth embodiment of the present disclosure. The present embodiment can be combined with the solution of the above embodiments. In the present embodiment, the landscape screen interaction method can further include: receiving a fourth trigger operation acting on the first associated information in the second display region; presenting the first associated information based on the fourth trigger operation.

As shown in FIG. 4, the method of the present embodiment can comprise:

S410, receiving a first trigger operation acting on a target interaction control of a video playing region of a first video in a landscape display page.

S420, in response to the first trigger operation, resizing the video playing region to a first display region of the landscape display page, and presenting first associated information corresponding to the first video in a second display region of the landscape display page.

S430, receiving a fourth trigger operation acting on the first associated information in the second display region.

The fourth trigger operation can be understood as an operation for triggering interaction with the first associated information in the second display region.

In one embodiment, the fourth trigger operation includes at least one of the following operations: a browse operation for browsing the first associated information; an edit operation for editing the first associated information; or a view operation for viewing details of the first associated information.

Illustratively, the fourth trigger operation can be a browse trigger operation acting on the second display region. The browse trigger operation is acted for browsing the first associated information. The browse trigger operation can be a roll operation or a drag operation or the like input for the first associated information.

Illustratively, the fourth trigger operation can be a view trigger operation acting on the second display region. The view trigger operation is acted for viewing details of the first associated information. The view trigger operation can be an operation for displaying hidden content input for the target view item of the first associated information, for example, an operation of clicking a view control such as “more” or “expand”. The view trigger operation can also be an operation of jumping to a detail page input for a target view item of the first associated information, for example, a click operation input for a hyperlink to the target view item of the first associated information, or the like.

Illustratively, the fourth trigger operation can be an edit trigger operation acting on the second display region. The edit trigger operation is acted for editing the first associated information. The edit trigger operation can be addition, modification, hiding, interaction, deletion, or other operations performed on the first associated information. There are various modes for interaction, for example, giving likes or gift, etc.

S440, presenting the first associated information based on the fourth trigger operation.

As previously described, the fourth trigger operation can be used for triggering browsing, editing, detail viewing, or the like on the first associated information. When the fourth trigger operation is received, in response to the fourth trigger operation, the first associated information can be controlled to be presented based on the fourth trigger operation.

Taking the example that the first associated information is comment information of the first video, it is possible to slide upward or downward in the second display region so as to browse the comment information of the first video, or make comments, delete comments, give likes to comment information, and the like in the second display region.

Taking the example that the first associated information is the video information of the same publisher as the first video, it is possible to slide or roll upward or downward in the second display region so as to browse other video information as published. By clicking the publisher's other video, the video currently displayed in the video playing region of the first display region can be switched to the selected video for playing.

The technical solution of the present embodiment not only can simultaneously display the first video and the first associated information on the landscape display page, but also can receive the fourth trigger operation acting on the first associated information in the second display region, and present the first associated information based on the fourth trigger operation. It can realize independent operations on the first associated information in the second display region, and can also realize independent operations on the first associated information without influencing the displaying of the first video, which meets the individual requirements of the user, and greatly improves the user experience.

### Fifth Embodiment

FIG. 5 is a schematic structural diagram of a landscape screen interaction apparatus as provided in a fifth embodiment of the present disclosure. The landscape screen interaction apparatus can be implemented in form of software and/or hardware. As shown in FIG. 5, the landscape screen interaction apparatus includes: an interaction triggering module 510 and a displaying module 520.

The interaction triggering module 510 is configured to receive a first trigger operation acting on a target interaction control of a video playing region of a first video in a landscape display page. The displaying module 520 is configured to, in response to the first trigger operation, resize the video playing region to a first display region of the landscape display page, and present first associated information corresponding to the first video in a second display region of the landscape display page.

In the technical solution of the embodiment of the present disclosure, by receiving a first trigger operation acting on a target interaction control of a video playing region of a first video in a landscape display page and determining first associated information corresponding to the first trigger operation, displaying of the first associated information can be triggered through the target interaction control of the video playing region, which has a simple trigger mode and is easy to operate. Then, in response to the first trigger operation, by resizing the video playing region to the first display region of the landscape display page and presenting the first associated information in the second display region of the landscape display page, the first video and the first associated information can be simultaneously displayed in the same landscape display page without a need to frequently switch pages, which solves the technical problem of complicated and inefficient information interaction in the related technologies, and achieves the technical effect of increasing information interaction efficiency, realizing high intelligence, and improving user interaction experience.

On the basis of the above technical solution, the landscape screen interaction apparatus can further comprise:
a switch triggering module, configured to receive a second trigger operation for switching the first video; a video switching module, configured to, in response to the second trigger operation, switch the first video in the video playing region to a second video.

On the basis of the above technical solution, the landscape screen interaction apparatus can further comprise:
an associated information switching module, configured to switch the first associated information in the second display region to second associated information corresponding to the second video.

On the basis of the above technical solution, the switch triggering module can be configured to perform at least one of the following operations:
receiving a slide switching operation acting on a video playing picture of the first video; receiving a switching operation acting on a preset video switching control in the video playing region; if the first associated information includes at least one recommended video, receiving a selection operation acting on the recommended video.

On the basis of the above technical solution, the landscape screen interaction apparatus can further include:
an interaction stop triggering module, configured to receive a third trigger operation for stopping displaying the first associated information; a video scaling-up module, configured to, in response to the third trigger operation, stop displaying the first associated information and scale up the video playing region for displaying.

On the basis of the above technical solution, the video scaling-up module can be configured to:
scale up the video playing region to a target display region for displaying, wherein the target display region is determined according to the first display region and the second display region.

On the basis of the above technical solution, the interaction triggering module 510 is configured to: receive a trigger operation acting on a comment identifier in the landscape display page; and accordingly, the displaying module 520 can be configured to present first comment information corresponding to the first video in a second display region of the landscape display page.

On the basis of the above technical solution, the interaction triggering module 510 is configured to: receive a trigger operation acting on a publisher identifier of the first video in the landscape display page; and accordingly, the displaying module 520 can be configured to: present the video information published by the publisher corresponding to the first video in a second display region of the landscape display page.

On the basis of the above technical solution, the second display region displays a home page jump identifier; and the landscape screen interaction method further includes:
a home page jumping module, configured to receive a trigger operation acting on a home page jump identifier in the second display region and jump to a portrait display page, wherein the portrait display page displays personal home page information of a publisher of the first video.

On the basis of the technical solution, the second display region is located in a region outside the first display region in the landscape display page.

The landscape screen interaction apparatus as provided by the embodiment of the present disclosure can perform the landscape screen interaction method as provided by any embodiment of the present disclosure, and have corresponding functional modules and effects for performing the landscape screen interaction method.

The plurality of units and modules included in the above apparatus are merely divided according to functional logic, but are not limited to the above division as long as the corresponding functions can be realized. In addition, the names of the plurality of functional units are only for convenience of distinguishing from each other, and are not used to limit the protection scope of the embodiments of the present disclosure.

### Sixth Embodiment

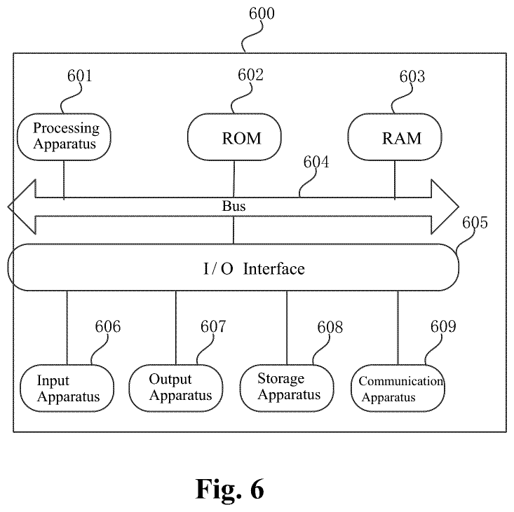

Referring now to FIG. 6, which shows a schematic structural diagram of an electronic device (e.g., a terminal apparatus or server) 600 adaptive for implementing the embodiment of the present disclosure. The terminal apparatus 600 in the embodiment of the present disclosure can include, but is not limited to, mobile terminals such as a mobile phone, a laptop computer, a digital broadcast receiver, a Personal Digital Assistant (PDA), a Tablet Computer (PAD), a Portable Multimedia Player (PMP), a vehicle-mounted terminal (e.g., a vehicle-mounted navigation terminal), and the like, as well as fixed terminals such as a Digital Television (TV), a desktop computer, and the like. The electronic device 600 shown in FIG. 6 is only an example and should not bring any limitation to the functions and the scope of use of the embodiment of the present disclosure.

As shown in FIG. 6, the electronic device 600 can include a processing apparatus (e.g., a central processor, a graphics processor, etc.) 601 that can perform various suitable actions and processes according to programs stored in a Read-Only Memory (ROM) 602 or programs loaded from a storage apparatus 608 onto a Random Access Memory (RAM) 603. In the RAM 603, various programs and data required for operations of the electronic device 600 are also stored. The processing apparatus 601, the ROM 602, and the RAM 603 are connected to each other via a bus 604. An Input/Output (I/O) interface 605 is also connected to the bus 604.

Generally, the following apparatuses can be connected to the I/O interface 605: input apparatus 606 including, for example, a touch screen, a touch pad, a keyboard, a mouse, a camera, a microphone, an accelerometer, a gyroscope, and the like; output apparatus 607 including, for example, a Liquid Crystal Display (LCD), a speaker, a vibrator, and the like; storage apparatus 606 including, for example, a magnetic tape, a hard disk, and the like; and a communication apparatus 609. The communication apparatus 609 can allow the electronic device 600 to communicate with other apparatuses in a wireless or wired way to exchange data. While FIG. 6 illustrates an electronic device 600 having various apparatuses, not all illustrated apparatuses are required to be implemented or provided. More or fewer apparatuses can be alternatively implemented or provided.

According to the embodiment of the present disclosure, the process described above with reference to the flow diagrams can be implemented as a computer software program. For example, the embodiment of the present disclosure includes a computer program product comprising a computer program carried on a non-transitory computer readable medium, the computer program containing program code for performing the method illustrated by the flow diagram. In such an embodiment, the computer program can be downloaded and installed from network through the communication apparatus 609, or installed from the storage apparatus 608, or installed from the ROM 602. The computer program, when executed by the processing apparatus 601, performs the above-described functions defined in the method of the embodiment of the present disclosure.

The electronic device provided by the embodiment of the present disclosure and the landscape screen interaction method provided by the above embodiments belong to the same concept. The technical details that are not described in detail in the present embodiment can be known referring to the above embodiments, and the present embodiment has the same effect as the above embodiments.

### Seventh Embodiment

The embodiment of the present disclosure provides a computer storage medium having a computer program stored thereon, which, when executed by a processor, performs the landscape screen interaction method provided by the above embodiments.

The above computer readable medium of the present disclosure can be a computer readable signal medium or a computer readable storage medium or any combination of both of the above. A computer readable storage medium can be, for example, but not limited to, an electronic, magnetic, optical, electromagnetic, infrared, or semiconductor system, apparatus, or component, or any combination of the above. Examples of the computer readable storage medium can include, but are not limited to: an electrical connection having one or more wires, a portable computer diskette, a hard disk, a RAM, a ROM, an Erasable Programmable Read-Only Memory (EPROM or flash Memory), an optical fiber, a portable Compact Disc Read-Only Memory (CD-ROM), an optical storage component, a magnetic storage component, or any suitable combination of the above. In the present disclosure, the computer readable storage medium can be any tangible medium that contains or stores a program for use by or in combination with an instruction execution system, apparatus, or device. In contrast, in the present disclosure, the computer readable signal medium can include a data signal propagated in baseband or as part of carrier wave, with computer readable program code carried therein. Such a propagated data signal can take a variety of forms, including, but not limited to, an electromagnetic signal, an optical signal, or any suitable combination of the above. The computer readable signal medium can be any computer readable medium other than a computer readable storage medium, and can send, propagate, or transport a program for use by or in combination with an instruction execution system, apparatus, or device. Program code contained on a computer readable medium can be transported using any suitable medium, including but not limited to: electrical wires, optical cables, Radio Frequency (RF), and the like, or any suitable combination of the above.

In some embodiments, clients and servers can communicate using any currently known or future developed network Protocol, such as the HyperText Transfer Protocol (HTTP), and can be interconnected with digital data communication (e.g., a communication network) of any form or medium. Examples of the communication network include a Local Area Network (LAN), a Wide Area Network (WAN), network of networks (e.g., Internet), peer-to-peer networks (e.g., ad hoc peer-to-peer networks), and any currently known or future developed Network.

The above computer readable medium can be contained in the above electronic device, or can be separate and not assembled into the electronic device.

The above computer readable medium carries one or more programs which, when executed by the electronic device, cause the electronic device to: receive a first trigger operation acting on a target interaction control of a video playing region of a first video in a landscape display page; in response to the first trigger operation, resize the video playing region of the first video to a first display region of the landscape display page, and present first associated information corresponding to the first video in a second display region of the landscape display page.

Computer program code for performing operations of the present disclosure can be written in one or more programming languages or a combination thereof. The above programing languages include, but are not limited to, object oriented programming languages such as Java, Smalltalk, and C++, as well as conventional procedural programming languages, such as the “C” programming language or similar programming languages. The program code can be executed entirely on a user computer, partly on the user computer, as a stand-alone software package, partly on the user computer and partly on a remote computer, or entirely on the remote computer or server. In the situation where a remote computer is involved, the remote computer can be connected to the user computer via any type of network, including a LAN or a WAN, or connected to an external computer (for example, connected via the Internet using an Internet service provider).

The flow diagrams and block diagrams in the figures illustrate the architecture, functions, and operations of possible implementations of systems, methods and computer program products according to various embodiments of the present disclosure. In this regard, each block in the flow diagrams or block diagrams can represent a module, a program segment, or part of code, which contains one or more executable instructions for implementing the specified logical function(s). It should also be noted that, in some alternative implementations, the functions labeled in the block can also occur out of the order labeled in the figures. For example, two blocks shown in succession can, in fact, be executed substantially in parallel, or the blocks can sometimes be executed in the reverse order, depending upon the functions involved. It will also be noted that each block of the block diagrams and/or flow diagrams, and combinations of blocks in the block diagrams and/or flow diagrams, can be implemented by dedicated hardware-based systems that perform the specified functions or acts, or combinations of dedicated hardware and computer instructions.

The involved units described in the embodiments of the present disclosure can be implemented by means of software or hardware. The name of a unit or module does not in one case constitute a limitation of the unit or module itself, for example, a target video playing module can also be described as a “video playing module”.

The functions described herein above can be performed, at least in part, by one or more hardware logic components. For example, without limitation, exemplary types of hardware logic components that can be used include: field Programmable Gate Arrays (FPGAs), Application Specific Integrated Circuits (ASICs), Application Specific Standard Parts (ASSPs), System On Chips (SOCs), Complex Programmable Logic Devices (CPLDs), etc.

In the context of the present disclosure, a machine readable medium can be a tangible medium that can contain or store programs for use by or in combination with an instruction execution system, apparatus, or devices. The machine readable medium can be a machine readable signal medium or a machine readable storage medium. The machine readable medium can include, but is not limited to, an electronic, magnetic, optical, electromagnetic, infrared, or semiconductor system, apparatus, or device, or any suitable combination of the above. Examples of the machine readable storage medium can include an electrical connection based on one or more wires, a portable computer diskette, a hard disk, a RAM, a ROM, an EPROM or flash memory, an optical fiber, a CD-ROM, an optical storage device, a magnetic storage device, or any suitable combination of the above.

According to one or more embodiments of the present disclosure, [First Example] provides a landscape screen interaction method, the method comprising:
receiving a first trigger operation acting on a target interaction control of a video playing region of a first video in a landscape display page;
in response to the first trigger operation, resizing the video playing region to a first display region of the landscape display page, and presenting first associated information corresponding to the first video in a second display region of the landscape display page.

According to one or more embodiments of the present disclosure, [Second Example] provides a landscape screen interaction method, further comprising:
receiving a second trigger operation for switching the first video;
in response to the second trigger operation, switching the first video in the video playing region to a second video.

According to one or more embodiments of the present disclosure, [Third Example] provides a landscape screen interaction method, further comprising:
switching the first associated information in the second display region to second associated information corresponding to the second video.

According to one or more embodiments of the present disclosure, [Fourth Example] provides a landscape screen interaction method, wherein,
the receiving a second trigger operation for switching the first video includes at least one of the following operations:
receiving a slide switching operation acting on a video playing picture of the first video;
receiving a switching operation acting on a preset video switching control in the video playing region;
if the first associated information includes at least one recommended video, receiving a selection operation acting on the recommended video.

According to one or more embodiments of the present disclosure, [Fifth Example] provides a landscape screen interaction method, further comprising:
receiving a third trigger operation for stopping displaying the first associated information;

in response to the third trigger operation, stopping displaying the first associated information, and scaling up the video playing region for displaying.

According to one or more embodiments of the present disclosure, [Sixth Example] provides a landscape screen interaction method, wherein,
the scaling up the video playing region includes:
scaling up the video playing region to a target display region for displaying, wherein the target display region is determined according to the first display region and the second display region.

According to one or more embodiments of the present disclosure, [Seventh Example] provides a landscape screen interaction method, wherein,
the receiving a first trigger operation acting on a target interaction control of a video playing region of a first video in a landscape display page includes:
receiving a trigger operation acting on a comment identifier in the landscape display page;
the presenting first associated information corresponding to the first video in a second display region of the landscape display page includes:
presenting first comment information corresponding to the first video in a second display region of the landscape display page.

According to one or more embodiments of the present disclosure, [Eighth Example] provides a landscape screen interaction method, wherein,
the receiving a first trigger operation acting on a target interaction control of a video playing region of a first video in a landscape display page includes:
receiving a trigger operation acting on a publisher identifier of a first video in the landscape display page;
the presenting first associated information corresponding to the first video in a second display region of the landscape display page includes:
presenting video information published by a publisher corresponding to the first video in the second display region of the landscape display page.

According to one or more embodiments of the present disclosure, [Ninth Example] provides a landscape screen interaction method, wherein,
the second display region displays a home page jump identifier, and the method further comprises:
receiving a trigger operation acting on the home page jump identifier in the second display region, and jumping to a portrait display page, wherein the portrait display page displays personal home page information of a publisher of the first video.

According to one or more embodiments of the present disclosure, [Tenth Example] provides a landscape screen interaction method, wherein,

the second display region is located in a region outside the first display region in the landscape display page.

According to one or more embodiments of the present disclosure, [Eleventh Example] provides a landscape screen interaction apparatus, the apparatus comprising:
an interaction triggering module, configured to receive a first trigger operation acting on a target interaction control of a video playing region of a first video in a landscape display page;
a displaying module, configured to, in response to the first trigger operation, resize the video playing region to a first display region of the landscape display page, and present first associated information corresponding to the first video in a second display region of the landscape display page.

Besides, while operations are depicted in a particular order, this should not be understood as requiring that these operations be performed in the particular order shown or in a sequential order. Under certain circumstances, multitasking and parallel processing can be advantageous. Likewise, while numerous implementation details are contained in the above discussion, these should not be construed as limitations on the scope of the present disclosure. Some features that are described in the context of separate embodiments can also be implemented in combination in a single embodiment. Conversely, various features that are described in the context of a single embodiment can also be implemented in multiple embodiments separately or in any suitable sub-combination.

What is claimed is:

1. A landscape screen interaction method, comprising:
receiving a first trigger operation acting on a target interaction control of a video playing region of a first video in a landscape display page;
in response to the first trigger operation, resizing the video playing region to a first display region of the landscape display page, and presenting first associated information corresponding to the first video in a second display region of the landscape display page.

2. The method according to claim 1, further comprising:
receiving a second trigger operation for switching the first video;
in response to the second trigger operation, switching the first video in the video playing region to a second video.

3. The method according to claim 2, further comprising:
switching the first associated information in the second display region to second associated information corresponding to the second video.

4. The method according to claim 2, wherein the receiving a second trigger operation for switching the first video comprises at least one of the following operations:
receiving a slide switching operation acting on a video playing picture of the first video;
receiving a switching operation acting on a preset video switching control in the video playing region;
in a case where the first associated information includes at least one recommended video, receiving a selection operation acting on the recommended video.

5. The method according to claim 1, further comprising:
receiving a third trigger operation for stopping displaying the first associated information;
in response to the third trigger operation, stopping displaying the first associated information, and scaling up the video playing region for displaying.

6. The method according to claim 5, wherein the scaling up the video playing region for displaying comprises:
scaling up the video playing region to a target display region for displaying, wherein the target display region is determined according to the first display region and the second display region.

7. The method according to claim 1, wherein the receiving a first trigger operation acting on a target interaction control of a video playing region of a first video in a landscape display page comprises:
receiving a trigger operation acting on a comment identifier in the landscape display page;
the presenting first associated information corresponding to the first video in a second display region of the landscape display page comprises:
presenting first comment information corresponding to the first video in the second display region of the landscape display page.

8. The method according to claim 1, wherein the receiving a first trigger operation acting on a target interaction control of a video playing region of a first video in a landscape display page comprises:
receiving a trigger operation acting on a publisher identifier of the first video in the landscape display page;
the presenting first associated information corresponding to the first video in a second display region of the landscape display page comprises:
presenting video information published by a publisher corresponding to the first video in the second display region of the landscape display page.

9. The method according to claim 1, wherein the second display region displays a home page jump identifier; the method further comprising:
receiving a trigger operation acting on the home page jump identifier in the second display region, and jumping to a portrait display page, wherein the portrait display page displays personal home page information of a publisher of the first video.

10. The method according to claim 1, wherein the second display region is located in a region outside the first display region in the landscape display page.

11. (canceled)

12. An electronic device, comprising:
at least one processor;
a storage apparatus, configured to store at least one program;
when executed by the at least one processor, the at least one program causing the least one processor to implement the landscape screen interaction method comprising the following operations:
receiving a first trigger operation acting on a target interaction control of a video playing region of a first video in a landscape display page;
in response to the first trigger operation, resizing the video playing region to a first display region of the landscape display page, and presenting first associated information corresponding to the first video in a second display region of the landscape display page.

13. A non-transitory computer readable storage medium storing a computer program, the program, when executed by a processor, implementing the landscape screen interaction method comprising the following operations:
receiving a first trigger operation acting on a target interaction control of a video playing region of a first video in a landscape display page;
in response to the first trigger operation, resizing the video playing region to a first display region of the landscape display page, and presenting first associated information corresponding to the first video in a second display region of the landscape display page.

14. The electronic device according to claim 12, the landscape screen interaction method further comprising:
receiving a second trigger operation for switching the first video;
in response to the second trigger operation, switching the first video in the video playing region to a second video.

15. The electronic device according to claim 14, the landscape screen interaction method further comprising:
switching the first associated information in the second display region to second associated information corresponding to the second video.

16. The electronic device according to claim 14, wherein the receiving a second trigger operation for switching the first video comprises at least one of the following operations:
receiving a slide switching operation acting on a video playing picture of the first video;
receiving a switching operation acting on a preset video switching control in the video playing region;
in a case where the first associated information includes at least one recommended video, receiving a selection operation acting on the recommended video.

17. The electronic device according to claim 12, the landscape screen interaction method further comprising:
receiving a third trigger operation for stopping displaying the first associated information;
in response to the third trigger operation, stopping displaying the first associated information, and scaling up the video playing region for displaying.

18. The non-transitory computer readable storage medium according to claim 13, the landscape screen interaction method further comprising:
receiving a second trigger operation for switching the first video;
in response to the second trigger operation, switching the first video in the video playing region to a second video.

19. The non-transitory computer readable storage medium according to claim 18, the landscape screen interaction method further comprising:
switching the first associated information in the second display region to second associated information corresponding to the second video.

20. The non-transitory computer readable storage medium according to claim 18, wherein the receiving a second trigger operation for switching the first video comprises at least one of the following operations:
receiving a slide switching operation acting on a video playing picture of the first video;
receiving a switching operation acting on a preset video switching control in the video playing region;
in a case where the first associated information includes at least one recommended video, receiving a selection operation acting on the recommended video.

21. The non-transitory computer readable storage medium according to claim 13, the landscape screen interaction method further comprising:
receiving a third trigger operation for stopping displaying the first associated information;
in response to the third trigger operation, stopping displaying the first associated information, and scaling up the video playing region for displaying.
